(19) United States
(12) Patent Application Publication
(10) Pub. No.: US 2003/0018824 A1
(43) Pub. Date: Jan. 23, 2003

(54) Method for generating commands to be interpreted by network controller modules of peripheral devices in electrical systems

(76) Inventor: Roberto Ponticelli, Caracas (VE)

Correspondence Address: JEFFREY FURR, 253 N. MAIN STREET, JOHNSTOWN, OH, 43031, US

(21) Appl. No.: 09/682,096

(22) Filed: Jul. 19, 2001

(51) Int. Cl. G06F 15/16

(52) U.S. Cl. 709/253; 709/236

(57) ABSTRACT

The present method describes a format for the generation and processing of commands interpreted by network controller modules of peripheral devices in electrical systems. These commands create the possibility of device intercommunication through a network; offer reliability in the modification of remote module configuration; and offer capability of working with internal parameters of remote modules. The versatility of their structuring allows easy creation of new commands according to the requirements of the system.

### BACKGROUND OF INVENTION

1. Background Field of Invention

This invention relates to electrical control communication systems and, more particularly, to a command system for data transmission between control units arranged in a network.

2. Background Prior Art

Many commercially available products provide control and communications in a network environment. These products range from very expensive, elaborate systems, to simple systems having little intelligence. The present invention is directed towards providing a system having a relatively large amount of intelligence and computational power but at a low cost.

One commercially available system (i.e., “X-10”) offers control, e.g., between a light switch and a light source. When the light switch is operated, a code pattern is transmitted over the power lines to a receiver at the light. The code pattern is transmitted twice, once in its true form and once in its complementary form. When the code is received by the receiver, it is interpreted and thereby used to control the light. Mechanical addressing means are needed to allow the transmitter at the switch to communicate with the specific receiver at the light.

The command protocol disclosed herein provides great flexibility. The communication between cells is optimized for the performance of the functions assigned to units, rather than for transmission of data unrelated to the control function of the network. For this reason, in general, packets carrying messages are relatively short compared to Ethernet, Arpa, Apple Talk, X-25 and many other broadband and data communication systems.

Through the proposed command system, device-generated network traffic can be minimized, thus allowing several units to use one network without reducing communication quality or increasing the wait period before information can be transmitted. This approach is so versatile that it supports extremely simple communication networks, comparable in capacity and reliability to other existing network systems, without any needed modification.

### SUMMARY OF INVENTION

The present invention discloses a method to generate commands for control device intercommunication across a network. Through these commands, interdevice information transmission and exchange is made possible. In addition, the present method supports the transmission of requests of actions to be executed by devices across the network. The command format is easy to implement, and uses very few device resources: a very important issue for the implementation of low-cost networks. The versatility of this method allows transmission of both information and requests of actions to be performed by other devices. The versatility of implementation of the commands allows the use of this system in different types of device networks, where there may be one master and several slaves, or several masters and several slaves, or where dynamic mode setting can be used as necessary.

### OBJECTS AND ADVANTAGES OF INVENTION

Accordingly, several objects of the present invention are:-To provide a format for data structure processing that allows communication among control devices in a network;-To provide a data structure that can be easily decoded by network devices, which consumes very few resources, and reduces implementation costs;-To provide a standard format that allows the inclusion of new commands in the command set already used in a network, maintaining compatibility with devices that do not have the new complete set of commands;-To provide a command system that permits reliable critical data transmission, such as device configuration parameters and network-controller system variables.

In addition, several advantages of the present invention are:-The use of very few network device resources, thus reducing implementation costs and allowing the use of low-capacity and low-resource controllers for computations and communication handling;-Reduced amount of fields to transmit by information packet, reducing the channel's busy-time;-It is not necessary to transmit preambles to establish synchronization between the command transmitter and receiver;-The possibility of using different packets lengths with no need to modify the information processing algorithm;-Ease of information packet delivery, with no need of using packet switching devices nor routers;-The versatility of functions provided to the network units in which it is implemented. The functions may handle the distribution of packets within subnets, handle the group directions, and handle group functions, among others.

### BRIEF DESCRIPTION OF DRAWINGS

FIG. 1 Fixed-function Master/Slaves Network

FIG. 2 Dynamic-function Master/Slaves Network

FIG. 3 Stand-by unit in the Network

FIG. 4 Master to Slave communication

FIG. 5 Remote unit intercommunication

FIG. 6 Communication Packet

FIG. 7 Communication flow

FIG. 8 Main Communication algorithm

### REFERENCE NUMERALS

2 Network bus.

4 Master unit.

6 Slave unit.

8 Dynamic-mode Master unit.

10 Dynamic-mode Slave unit.

12 Stand-by unit.

14 Communication packets.

16 Acknowledge packets.

### DETAILED DESCRIPTION

Detailed Description of Drawings

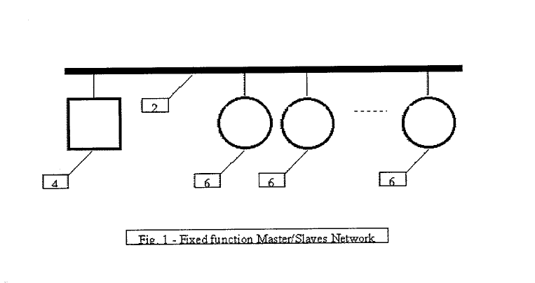

FIG. 1—Fixed function Master/Slaves Network Let there be a basic device network comprising a master unit 4 and N remote units 6, each having its own network address that uniquely identifies it in the network. Interconnection of units exists by means of bus 2. In this example, the mode of each unit is fixed. The masters will always be masters, and slaves will always be slaves.

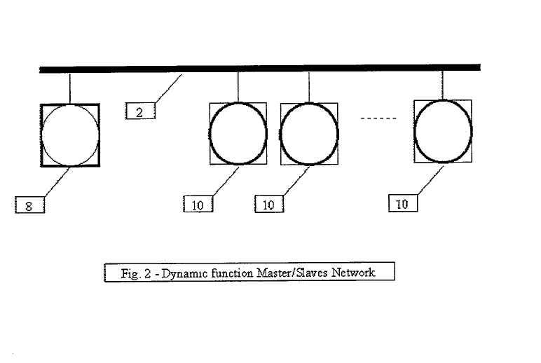

FIG. 2—Dynamic function Master/Slaves Network The device network may comprise units in dynamic mode. These units may switch between master-mode and slave-mode as necessary. When a unit switches to master-mode, the rest of the units must switch to slave-mode. The master units 8 connect to slave units 10 through bus 2.

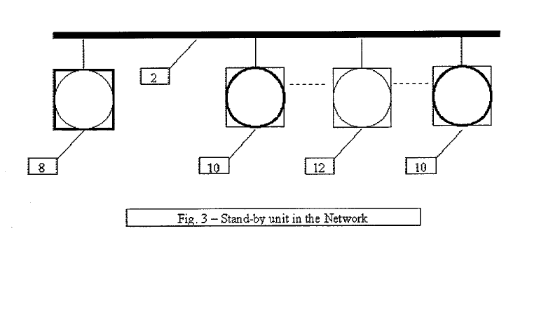

FIG. 3 Stand-by unit in the Network In addition to master- and slave-modes, it is possible to set units to operate in stand-by mode 12. Stand-by units act as hidden slave units, listening to the network without sending data or acknowledges out to it.

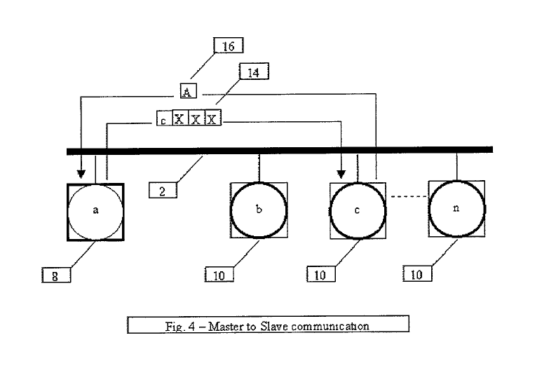

FIG. 4 Master to Slave communication In the communication process, a master unit 8 sends an information packet 14 through the bus 2 to a slave 10. An acknowledge bit 16 is received from the slave 10 for each received byte. Packet 14 contains the address of the destination unit (i.e., the unit the packet must reach).

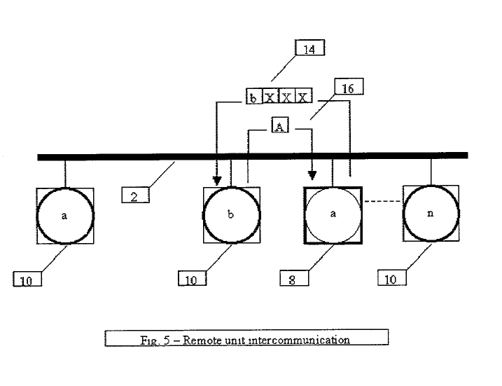

FIG. 5 Remote unit intercommunication When units have the capacity of dynamic mode, any unit may switch to master-mode 8 while the others remain in slave-mode 10. This way, any unit may send information to any other unit connected to the same bus 2 using the same communication and packet format.

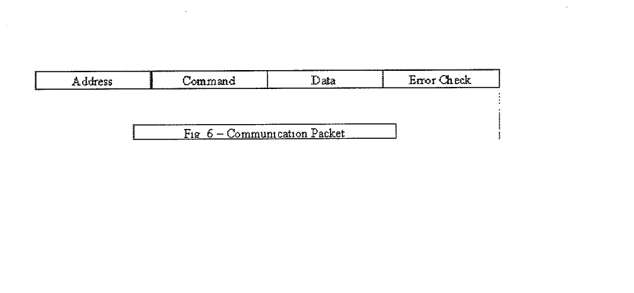

FIG. 6 Communication Packet Information is encapsulated in packets for transmission. In general, these comprise four fields, each consisting of several bytes. The first field corresponds to the packet's destination address, and specifies the remote unit that must ultimately receive the packet. The second field corresponds to the command that specifies the function of the information contained in the packet. This command may indicate that the receiving unit must execute a specific action, process the packet's data in a specific manner, or generate a reply with information contained in the remote unit (i.e., request/response). The third field corresponds to data. This data may originate in the master unit and be sent to a slave unit, or be contained in a slave unit and be requested by the master unit, or a combination of both, where both master and slave units supply information. This is a bi-directional field, and its nature is determined by the command contained in the second field. The fourth field corresponds to information for communication verification or error detection. It may contain CRC, checksum, or other value.

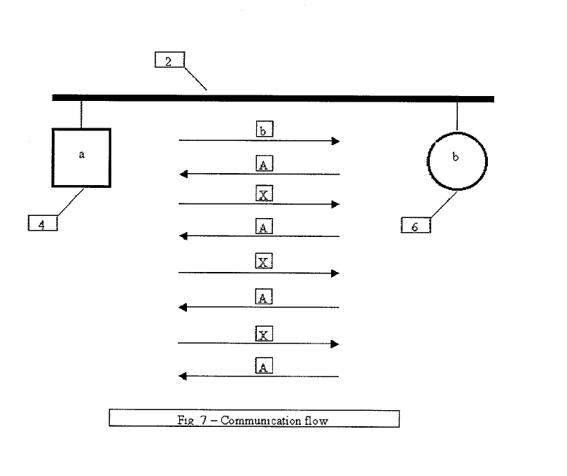

FIG. 7 Communication flow In the communication process, the master unit 4 sends information bytes, and the slave unit 6 confirms reception of a packet by sending acknowledge (i.e., ACK) bits back to the master unit 4. The communication at any moment is bi-directional. This way, communication errors may be detected during the process, without having to wait until the end of the process.

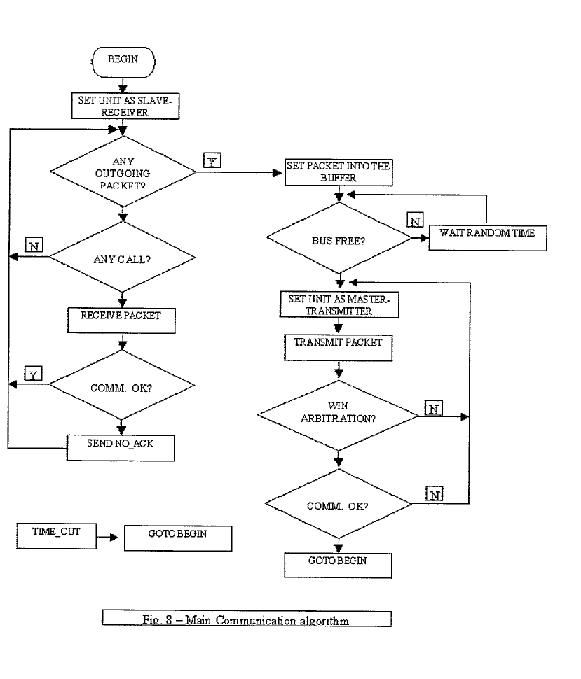

FIG. 8 Main Communication algorithm The communication algorithm of remote units with capacity of dynamic-mode comprises several basic blocks. When a new device enters the network, it is set to slave-receiver mode so that it can listen to the bus. If it needs to transmit information, it is set to master-transmitter. In this case, it generates an information packet, verifies that the bus is available, and checks the bus's state of arbitration to avoid collisions. Then it transmits the packet. If a call is received, the unit receives the packet. If an error in the transmission process is detected, a unit may reattempt packet transmission. The entire process is always checked by a time clock. This ensures that the system is not locked in a loop, generating a jump to the beginning of the communication algorithm.

Operation Of Invention

A master 4 is the device providing the signaling necessary to transmit information through the network. A slave 6 is the device receiving the information from the network, using the signaling present in the network bus 2. In case of a network in which the communication modules mode is defined so that the central module is the master 4 and the remote units are slaves 6, communication is established only when the master initiates it. If a remote slave unit 6 must transmit information to its master, it must wait for the master's call. In case of a network in which the communication modules mode is interchangeable between masters and slaves, remote units have the possibility of addressing the central device and requesting attention from it.

In case of multimastering, a bus arbitration mechanism (i.e., bus arbiter) handles collisions when two or more masters 8 try to access the bus 2 simultaneously. It is possible to implement said bus arbiter through a dedicated bus arbitration device.

However, this is not necessary. If desired, the master units 8 may compare the state of their outputs against the actual state of the bus 2. When a difference between the master's output and the state of the bus occurs, it follows that a collision is taking place (i.e., two or more masters are trying to transmit simultaneously). Then, the masters that detected the difference surrender access to the bus whereas the master whose output corresponded to the state of the bus gains access to the bus and continues transmission.

Through multimastering, it is possible to implement a network in which both remote and local devices may exchange information among them without the intervention of an intermediary device or a device with higher hierarchy. Through a multimaster network, it is possible to delegate administrative tasks to lower hierarchy network devices, while higher hierarchy devices carry out their tasks. The administrator device may be in charge of handling network messages of other devices, taking care of its requests and resolving conflicts of local significance within the network. Important messages can be forwarded to the higher hierarchy device for processing.

The generic format of the commands permits the implementation of this type of network structure since it contemplates addressing and data structures for information flow between devices regardless of hierarchy. Packets contain an address field, a command field, a data field and an error correction field. The address field specifies the recipient's network address. The command field specifies actions to be performed by the addressed remote device. The data field contains information associated with the command. This data may be information that the remote device requires, or it may be data to be sent to the master unit by the remote device (i.e., data request).

The error correction field contains information to used to check for errors in packet transmission. The error correction field may contain a checksum, calculated in the master unit from all bytes to be transmitted, and in the slave unit from all the bytes received from the network. Through this checksum, it is possible to check for errors in the received information. It is advisable to use the destination device's address to generate the value of the checksum. If the checksum computed at the destination device does not match the checksum included in the packet, the packet is discarded.

It is not necessary to implement the complete structure of these format specifications. It is possible to establish communications in which a simplified format is used, consisting of an address field, a command field, and a bi-directional data field. The error correction field may be omitted if the underlying communication bus 2 is considered sufficiently (i.e., highly) reliable. In order to guarantee system stability in cases where the simplified communications format has been used, it is possible to implement a set of “enabling” configuration command that warn remote devices that the following commands contain configuration information. If a remote unit receives a configuration command without first having received the enabling configuration command, the configuration command is discarded. This mechanism is quite useful in networks in which low information flow on the bus is highly important because remote unit configuration happens very infrequently.

The communication process is performed by sending information in byte segments and receiving acknowledge replies indicating the byte reception. Basically, bytes are sent and an acknowledge bit is received.

Communication starts with the transmission of the destination device's network address. Next, an acknowledge bit is expected. Once received, the following byte of information is transmitted, namely, the byte specifying the action that should be taken about the current communication process. In case of the typical process, this byte specifies the command to be executed at the remote unit. Next, a second acknowledge bit is expected. After receiving an acknowledge bit, the command data block is transmitted. This data can be sent from the master and can be read from the remote unit in the same packet (bi-directional communication), or in a single direction as in the case of a reading or configuration command.

The basic device communication algorithm is illustrated on the FIG. 8. Communication starts by configuring a device as a slave-receiver unit, which receives events originating in the network. If a packet must be transmitted, the unit prepares a buffer containing the information, checks the availability of the bus, and switches its mode to master-transmitter mode by itself, following the communication algorithm. While transmission is taking place, the bus access state (i.e., arbitration) is checked. If bus access is lost due to conflict, transmission is reattempted. If bus access is gained, corresponding acknowledges are expected for each transmitted field. When communication ends successfully, the process concludes and the device returns to the start state of the algorithm. However, if there were transmission problems, transmission is reattempted. The number of retries depends on the application and specific programming needs.

In case a network call is received during the wait-cycle of packet transmission (i.e., when acknowledges are expected), the packet is received and a corresponding acknowledge is sent out. If errors occur, a NO_ACK packet (i.e., the binary complement of an acknowledge packet) is sent to the master unit indicating that an error occurred. Then, the unit returns to the start of the network listening process.

The command protocol disclosed herein provides great flexibility. The communication between cells is optimized for the performance of the functions assigned to units, rather than for transmission of data unrelated to the control function of the network.

Through the proposed command system, device-generated network traffic can be minimized, thus allowing several units to use one network without reducing communication quality or increasing the wait period before information can be transmitted. This approach is so versatile that it supports extremely simple communication networks, comparable in capacity and reliability to other existing network systems, without any needed modification.

The versatility of implementation of the commands allows the use of this system in different types of device networks, where there may be one master and several slaves, or several masters and several slaves, or where dynamic mode setting can be used as necessary.

In addition, several advantages of the present invention are:-The use of very few network device resources, thus reducing implementation costs and allowing the use of low-capacity and low-resource controllers for computations and communication handling;-Reduced amount of fields to transmit by information packet, reducing the channel's busy-time;-It is not necessary to transmit preambles to establish synchronization between the command transmitter and receiver;-The possibility of using different packets lengths with no need to modify the information processing algorithm;-Ease of information packet delivery, with no need of using packet switching devices nor routers;-The versatility of functions provided to the network units in which it is implemented. The functions may handle the distribution of packets within subnets, handle the group directions, and handle group functions, among others.

While our above description contains many specificities, these should not be construed as limitations to the scope of the invention, but rather as an exemplification of one preferred embodiment thereof. Obviously, modifications and alterations will occur to others upon a reading and understanding of this specification such as, for example, a command set which implements an stronger acknowledge format, where the acknowledge packet contains the communication status so the transmitter can knows the actual condition of the packet actually being transmitted.

Another modification of the presented embodiment can occur having an addressing structure that contains both origin and target address, so the packets can be forwarded by any device without losing functionality, and furthermore, it can be useful to implement router devices that can interconnect several networks.

Another modification of the presented embodiment can occur having a packet structure with a different field structure, where the size, number and meaning of each field are adapted to the specificities of the actual application.

The descriptions above are intended, however, to include all such modifications and alterations insofar as they come within the scope of the appended claims or the equivalents thereof.

What is claimed is:

1. A method for the generation and processing of signaling necessary to transmit information through a network, the method comprising the steps of:
Using a bus to transmit data on the network;
Having a plurality of devices on the bus;
Using a bus arbitration device to control conflict of data transmissions on the bus;
Having the data be encapsulated in packets with the packets having the following fields, an address field, a command field and a bi-directional data field; and
Having a plurality of the devices with the ability to serve as a master device as well as a slave device.

2. The method of claim 1 in which said packets consist of an address field, a command field, a data field and an error correction field.

3. The method of claim 1 which includes the steps of:
having a device switch to a master device; and
having the rest of the plurlarity of devices on the bus set as slaves.

4. The method of claim 1 which includes the steps of:
setting up a plurlarity of devices on the bus in stand-by mode; and
having the plurlarity of devices in stand-by mode listen to the network without sending data or acknowledges.

5. The method of claim 1 in which a master device sends a data packet through the bus to a slave device, an acknowledge bit is sent to the master device from the slave device for each received byte, and said data packet contains the address of the destination device.

6. The method of claim 1 in which a device may switch to master while other devices remain as slave devices allowing any device to send data to any device connected to the bus.

7. The method of claim 1 which includes the step of having a slave device generate and send an acknowledge to the master device.

8. The method of claim 1 which includes the follow steps on the addition of a new device on the network:
Setting the new device as a slave device; and
Resetting the new device as a master device if the new device needs to sends data.

9. The method of claim 1 which includes the follow steps on the sending of data on the network:
Setting the device as a master device if it is not already set as a master device;
Checking the bus arbitration for availability of the bus;
Sending the data if the bus is available; and
Waiting a period of time if the bus is not free and repeat the previous two steps until the data is sent.

10. A network comprising:
A bus to transmit data on the network;
A plurality of devices on the bus;
A bus arbitration device to control conflict of data transmissions on the bus;
Data that is encapsulated in packets with the packets having the following fields, an address field, a command field and a bi-directional data field; and
A plurality of the devices serving as a master device as well as a slave device.

11. The network of claim 10 in which said packets consists of an address field, a command field, a data field and an error correction field.

12. The network of claim 10 which comprises:
a device that switches to a master device; and
having the rest of the plurlarity of devices on the bus set as slave devices.

13. The network of claim 10 which comprises:
setting up a plurlarity of devices on the bus in stand-by mode; and
having the plurlarity of devices in stand-by mode listens to the network without sending data or acknowledges.

14. The network of claim 10 in which a master unit device sends a data packet through the bus to a slave device, an acknowledge bit is sent from the slave device for each received byte, and said data packet contains the address of the destination device.

15. The network of claim 10 in which a device may switch to master while other devices remain as slave devices allowing any device to send data to any device connected to the bus.

16. The network of claim 10 in which the slave device generates and sends an acknowledge to the master device.

17. The network of claim 10 which comprises a new device which is set as a slave device and is reset to a master device if the new device needs to sends data.

18. The network of claim 10 which comprises:
a device that is set as a master device to send data if it is not already set as a master device, having the device checks the bus arbitration for availability of the bus, the device sends the data if the bus is available, the device will wait a period a period of time if the bus is not free and repeat the previous two steps until the data is sent.
